(19) United States
(12) Patent Application Publication
(10) Pub. No.: US 2013/0309468 A1
(43) Pub. Date: Nov. 21, 2013

(54) CBN SINTERED BODY TOOL AND COATED CBN SINTERED BODY TOOL

(71) Applicant: Takahide Kudo, Iwaki-shi (JP)

(72) Inventor: Takahide Kudo, Iwaki-shi (JP)

(73) Assignee: Tungaloy Corporation, Iwaki-shi, Fukushima (JP)

(21) Appl. No.: 13/982,718

(22) PCT Filed: Feb. 6, 2012
(86) PCT No.: PCT/JP2012/052592

§ 371 Date: Jul. 30, 2013

(30) Foreign Application Priority Data
Feb. 4, 2011 (JP) 2011-022692

(51) Int. Cl. B23B 27/14; C04B 35/5831

(52) U.S. Cl. CPC B23B 27/148; C04B 35/5831
USPC 428/216; 428/698; 428/336; 501/1; 501/153; 501/87; 501/93

(57) ABSTRACT

A cBN sintered body tool has a cBN sintered body which includes 40 to 85% by volume of cBN, the remainder being a binder phase including at least one selected from at least one metal selected from Ti, Zr, Hf, V, Nb, Ta, Cr, Mo, W, Co, Ni and Al, and at least one of a carbide, a nitride, a carbonitride, a boride and an oxide of these metals and mutual solid solutions thereof, and inevitable impurities. An amount of a Mo element contained in the cBN sintered body is 0.2 to 3.0% by weight based on a whole amount of the cBN sintered body.

### TECHNICAL FIELD

The present invention relates to a cBN sintered body tool and a coated cBN sintered body tool.

### BACKGROUND ART

cBN (cubic boron nitride) has higher hardness next to diamond and excellent thermal conductivity, and has a characteristic that it has a lower affinity with iron as compared with that of diamond. A cBN sintered body in which the cBN is sintered with a binder phase of ceramics or a metal is extremely excellent as a tool material, and many researches have been done for formation of bonding the cBN grains with each other and firm bonding of the cBN grains and the binder phase to improve cutting performances of the cBN sintered body tool.

As a prior art technique of the cBN sintered body tool, there is a cubic boron nitride-containing sintered body which comprises a sintered body comprising, in a volume ratio, 10 to 70% of cubic boron nitride and the remainder being a binder phase which comprises ceramics as the main component and inevitable impurities, wherein the binder phase comprises 5 to 30% of aluminum oxide, 3 to 20% of aluminum nitride and/or aluminum boride, 10 to 40% of one or more of titanium carbide, titanium nitride and titanium carbonitride, and 3 to 30% of titanium boride based on the ratio in the whole sintered body, and the aluminum oxide has a grain size of 1 μm or less (for example, see Patent Literature 1.).

Also, there is a high-pressure phase type boron nitride-base sintered body which comprises a plural number of high-pressure phase type boron nitride grains and a binder phase, the content of the above-mentioned grains is 20.0% by volume or more and 99.7% by volume or less, the binder phase contains a first binder phase which surrounds the above-mentioned grains, and a second binder phase other than the first one, the above-mentioned first binder phase comprises at least any one of the forms of a nitride of at least one of Ti, TiAl, Zr and Hf, or a solid solution thereof, the above-mentioned second binder phase contains a grain-growth controlling binder phase between the plural number of the above-mentioned grains surrounded by the above-mentioned first binder phase, and the above-mentioned grain-growth controlling binder phase comprises at least one of the forms of a boride of at least one of Ti, Zr and Hf, or a solid solution thereof, or at least one of the forms of a nitride or a boride of Al, or a solid solution thereof (for example, see Patent Literature 2.).

### PRIOR ART REFERENCES

### Patent Literatures

[Patent Literature 1] JP H07-82031A
[Patent Literature 2] JP H10-218666A

### SUMMARY OF THE INVENTION

### Problems to be Solved by the Invention

In recent years, in cutting, difficulty of cutting a work piece material has been increasing, and on the other hand, high efficiency for machining has been being required, and a cutting speed or feeding amount has been increasing. When the invention of the above-mentioned Patent Literature 1 or the invention of the above-mentioned Patent Literature 2 is used as a cutting tool, they have low wear resistance and fracture resistance, and have not sufficiently been able to respond to these requirements. The present invention has been done to solve the above-mentioned problems, and an object thereof is to provide a cBN sintered body tool and a coated cBN sintered body tool both excellent in wear resistance and fracture resistance, and can elongate their tool lives than those of the conventional ones.

### Means to Solve the Problems

The present inventor has intensively studied, and found that strength of a binder phase is increased by adding a small amount of Mo, Ni and Ta to a cBN sintered body, bonding of the cBN and the binder phase or bonding of the cBN grains with each other is advanced, and oxidation resistance of the cBN sintered body is further increased. When the cBN sintered body is used as a cutting tool, the effect that the tool life thereof can be elongated than those of the conventional ones, can be obtained. The gists of the present invention obtained by based on these findings are as follows.

(1) A cBN sintered body tool comprising a cBN sintered body which comprises 40 to 85% by volume of cBN, and the remainder being a binder phase and inevitable impurities, wherein the binder comprises at least one selected from at least one metal selected from Ti, Zr, Hf, V, Nb, Ta, Cr, Mo, W, Co, Ni and Al, and at least one of a carbide, a nitride, a carbonitride, a boride and an oxide of these metals and mutual solid solutions thereof, wherein an amount of a Mo element contained in the cBN sintered body is 0.2 to 3.0% by weight based on a whole amount of the cBN sintered body.
(2) The cBN sintered body tool described in (1), wherein an amount of the Ni element contained in the cBN sintered body is 0.2 to 3.0% by weight based on the whole amount of the cBN sintered body.
(3) The cBN sintered body tool described in (1) or (2), wherein an amount of the Ta element contained in the cBN sintered body is 0.1 to 3.5% by weight based on the whole amount of the cBN sintered body.
(4) The cBN sintered body tool described in any one of (1) to (3), wherein an amount of the W element contained in the cBN sintered body is 0 to 6% by weight based on the whole amount of the cBN sintered body.
(5) A coated cBN sintered body tool in which a film is coated on the surface of the cBN sintered body tool described in any one of (1) to (4).

The cBN sintered body of the present invention comprises cBN, a binder phase and inevitable impurities. If an amount of the cBN contained in the cBN sintered body of the present invention is increased and exceeds 85% by volume, lowering occurs in wear resistance due to progress of chemical reaction between a work piece material and the cBN, and also lowering occurs in fracture resistance due to progress of crater wear. To the contrary, if an amount of the cBN is less than 40% by volume, a ratio of the binder phase inferior in strength relatively increases so that lowering of fracture resistance and lowering of wear resistance due to lowering of thermal conductivity occur. Therefore, the cBN is 40 to 85% by volume. The cBN content is preferably 45 to 85% by volume, more preferably 45 to 82% by volume. The cBN content can be obtained by taking a picture of a cross-sectional structure of the cBN sintered body by SEM (scanning electron microscope), and the obtained photograph of the cross-sectional structure is image-analyzed.

The binder phase of the cBN sintered body of the present invention comprises at least one selected from the group consisting of at least one metal selected from Ti, Zr, Hf, V, Nb, Ta, Cr, Mo, W, Co, Ni and Al, a carbide, a nitride, a carbonitride, a boride and an oxide of at least one of these metals, and mutual solid solutions thereof. The binder phase of the present invention may be preferably mentioned at least one selected from the group consisting of at least one metal selected from W, Mo, Co and Ni, and a carbide, a nitride, a carbonitride, a boride and an oxide of at least one metal selected from Ti, Zr, Hf, V, Nb, Ta, Cr, Mo, W, Co, Ni and Al, and mutual solid solutions thereof, specifically mentioned TiN, TiCN, TiC, TiB₂, TiBN, TiAlN, Ti₂AlN, AlN, AlB₂, AlB₁₂, Al₂O₃, ZrC, HfC, VC, NbC, Cr₃C₂, Mo₂C, TaC, ZrN, HfN, VN, NbN, TaN, CrN, WC, WB, W₂B, CoWB, W₂Co₂₁B₆, Co₃W₃C, W, Mo, Co, Ni and mutual solid solutions thereof, etc., more preferably TiN, TiCN, TiC, TiB₂, AlN, AlB₂, AlB₁₂, Al₂O₃, Mo₂C, TaC, TaN, CrN, WC, WB, W₂B, CoWB, W₂Co₂₁B₆, Co₃W₃C, W, Mo, Co, Ni and mutual solid solutions thereof.

If an amount of the Mo element contained in the cBN sintered body of the present invention is 0.2% by weight or more based on the whole amount of the cBN sintered body, strength of the binder phase increases, bonding between the cBN and the binder phase is advanced, bonding of the cBN grains with each other is advanced, whereby both of wear resistance and fracture resistance of the cBN sintered body are improved. However, if an amount of the Mo element is increased and exceeds 3.0% by weight based on the whole amount of the cBN sintered body, both of wear resistance and fracture resistance of the cBN sintered body are lowered due to stress concentration to the Mo compound or Mo series solid solution, etc., or lowering of thermal conductivity of the cBN sintered body. Therefore, the amount of the Mo element is set to 0.2 to 3.0% by weight. To realize the matter, the amount of the Mo element in the raw powder is formulated so that it is within the range. The amount of the Mo element is preferably 0.2 to 2.5% by weight. The amount of the Mo element contained in the cBN sintered body can be measured by using an EDS (energy dispersive X-ray spectroscopy) or ICP-AES (Inductively coupled plasma atomic emission spectroscopy), etc.

When a Ni element is contained in the cBN sintered body of the present invention, there appears a tendency that strength of the binder phase increases, bonding of the cBN and the binder phase is advanced, bonding of the cBN grains with each other is advanced, whereby both of wear resistance and fracture resistance of the cBN sintered body are improved. However, if an amount of the Ni element is increased and exceeds 3.0% by weight based on the whole amount of the cBN sintered body, fracture resistance of the cBN sintered body tends to be lowered due to stress concentration to the Ni compound or Ni series solid solution, etc. Therefore, the amount of the Ni element is preferably 3.0% by weight or less. To realize the matter, the amount of the Ni element in the raw powder is formulated so that it is within the range. Among these, if an amount of the Ni element contained in the cBN sintered body of the present invention is 0.2% by weight or more based on the whole amount of the cBN sintered body, strength of the binder phase is increased, bonding of the cBN and the binder phase is advanced, bonding of the cBN grains with each other is advanced, and an effect of improving both of wear resistance and fracture resistance of the cBN sintered body becomes clear, therefore, the amount of the Ni element preferably 0.2 to 3.0% by weight, more preferably 0.5 to 2.5% by weight. The amount of the Ni element contained in the cBN sintered body can be measured by using an EDS or ICP-AES, etc.

When a Ta element is contained in the cBN sintered body of the present invention, there appears a tendency that oxidation resistance of the cBN sintered body is improved and wear resistance is excellent. However, if an amount of the Ta element contained in the cBN sintered body of the present invention becomes much exceeding 3.5% by weight based on the whole amount of the cBN sintered body, fracture resistance of the cBN sintered body tends to be lowered due to stress concentration to the Ta compound or Ta series solid solution, etc. Therefore, the amount of the Ta element is preferably 3.5% by weight or less. To realize the matter, the amount of the Ta element in the raw powder is formulated so that it is within the range. Among these, if the amount of the Ta element contained in the cBN sintered body of the present invention is 0.1% by weight or more based on the whole amount of the cBN sintered body, oxidation resistance of the cBN sintered body is improved and an effect of excellent in wear resistance becomes clear, so that it is preferably 0.1 to 3.5% by weight, more preferably 0.5 to 3.0% by weight. The amount of the Ta element contained in the cBN sintered body can be measured by using an EDS or ICP-AES, etc.

In the method for preparing the cBN sintered body of the present invention, it is preferred that ball mill mixing using balls of WC-based cemented carbide is carried out in the step of pulverizing and mixing, because a pulverization and mixing efficiency is good. However, when balls of WC-based cemented carbide are used, a W element is migrated into the cBN sintered body. The W element migrated into the cBN sintered body exists in the form of WC, WB, W₂B, CoWB, W₂Co₂₁B₆, Co₃W₃C, W, etc., in the binder phase of the cBN sintered body. Since these W metal and tungsten compound likely become an origination of fracture or cracks at the time of cutting, the amount of the W element contained in the cBN sintered body of the present invention is preferably 0 to 6% by weight based on the whole amount of the cBN sintered body, among these, 0 to 5% by weight is further preferred, and above all, 0 to 3% by weight is more preferred. The amount of the W element contained in the cBN sintered body of the present invention can be measured by using an EDS or ICP-AES, etc.

Inevitable impurities of the cBN sintered body of the present invention may be mentioned Fe migrated during the preparation steps of the cBN sintered body. A total amount of the inevitable impurities is 0.5% by weight or less based on the whole amount of the cBN sintered body, and it can be generally controlled to 0.1% by weight or less based on the whole amount of the cBN sintered body, therefore, they cannot affect to the characteristic values of the present invention. In the present invention, a small amount of other component(s) which cannot be said to be inevitable impurities may be contained other than the cBN, the binder phase and inevitable impurities in the range without impairing the characteristics of the cBN sintered body of the present invention.

It is further preferred that a film is coated on the surface of the cBN sintered body of the present invention, because wear resistance is improved. The film of the present invention comprises at least one selected from the group consisting of an oxide, a carbide, a nitride, a carbonitride and a boride of at least one metal selected from Ti, Zr, Hf, V, Nb, Ta, Cr, Mo, W, Al and Si and mutual solid solutions thereof. It may be specifically mentioned TiN, TiC, TiCN, (Ti,Al)N, (Ti,Si)N, (Al,Cr)N, Al₂O₃, etc. The film may preferably be either a single layered film or a laminated film of two or more layers, and an alternately laminated film in which thin films having different compositions with an average film thickness of 5 to 200 nm are alternately laminated, is also preferable. If the total film thickness of the whole film is less than 0.5 μm in an average film thickness, wear resistance is lowered, while if it exceeds 20 μm, fracture resistance is lowered, therefore, the total film thickness of the whole film is preferably 0.5 to 20 μm in an average film thickness, among these, it is further preferably 1 to 4 μm.

The cBN sintered body tool of the present invention is a cutting tool at least a cutting edge portion thereof comprises the cBN sintered body of the present invention. The whole cBN sintered body tool of the present invention may be constituted by the cBN sintered body of the present invention alone, or the portion other than the cutting edge portion may be a different material from the cBN sintered body of the present invention, for example, cemented carbide. For example, it may be a cutting tool in which the cBN sintered body of the present invention is attached to the cutting edge portion of cemented carbide with a shape of a cutting tool by brazing, whereby the cutting edge portion of which is processed to be the cBN sintered body of the present invention. Similarly, the coated cBN sintered body tool of the present invention is a cutting tool at least a cutting edge portion thereof comprises the coated cBN sintered body of the present invention in which a film is coated on the surface of the cBN sintered body of the present invention. The whole coated cBN sintered body tool of the present invention may be constituted by the coated cBN sintered body of the present invention alone, or the portion other than the cutting edge portion may be a different material from the coated cBN sintered body of the present invention, for example, cemented carbide or coated cemented carbide. For example, it may be a cutting tool in which the cBN sintered body of the present invention is attached to the cutting edge portion of cemented carbide with a shape of a cutting tool by brazing, whereby the cutting edge portion of which is processed to be the cBN sintered body of the present invention, and a film is further coated on the surface thereof.

The cBN sintered body of the present invention is increased in strength of the binder phase by adding a small amount of Mo, and bonding of the cBN and the binder phase, or bonding of the cBN grains with each other is advanced, so that it is excellent in wear resistance and fracture resistance. Therefore, the cBN sintered body tool of the present invention, at least the cutting edge portion of which is the cBN sintered body of the present invention, can elongate the tool life than the conventional ones. Among these, when the cBN sintered body tool of the present invention is used for a cBN sintered body tool for machining a hardened steel, it is further preferred since an elongation effect of the tool life is high. Similarly, the coated cBN sintered body tool of the present invention, at least the cutting edge portion of which is the coated cBN sintered body of the present invention, can elongate the tool life than the conventional ones. Among these, when the coated cBN sintered body tool of the present invention is used for a coated cBN sintered body tool for machining a hardened steel, it is further preferred since an elongation effect of the tool life is high.

An example of a preparation method of the cBN sintered body tool of the present invention is described as follows.

[Step 1] cBN powder, a binder phase-forming powder comprising at least one selected from the group consisting of a metal of Ti, Zr, Hf, V, Nb, Cr, W, Co and Al, a carbide, a nitride, a carbonitride, a boride and an oxide of at least one of these metals, and mutual solid solutions thereof, and additive(s) that is one or both of Mo metal powder and Mo₂C powder, and depending on necessity, Ni metal powder, and one or both of Ta metal powder and TaC powder, are prepared, and the cBN powder, the binder phase-forming powder and the additive(s) are weighed so that they are predetermined composition.
[Step 2] The binder phase-forming powder and the additive(s) are mixed by using, for example, a wet ball mill comprising balls, an organic solvent and a pot, and the organic solvent is evaporated to obtain a mixed powder.
[Step 3] The mixed powder is subjected to a heat treatment at a temperature of 700 to 1000° C. to carry out a reaction forming a brittle intermetallic compound to make it a phase having brittleness.
[Step 4] The phase having brittleness is mixed by using, for example, a wet ball mill comprising balls, an organic solvent and a pot, to finely pulverize.
[Step 5] To the powder pulverized in Step 4, the cBN powder is added and mixed, and they are uniformly dispersed. The mixing method at this time may be mentioned, for example, a wet ball mill with a mixing time of 1 to 10 hours, an ultrasonic wave mixing with a mixing time of 5 to 120 minutes, etc.
[Step 6] The mixed powder obtained in Step 5 is placed in a metal capsule made of, for example, Ta, Nb, Mo, Zr, etc., the metal capsule is mounted to an ultra-high pressure and high temperature generating device, and the powder is sintered under the conditions of a pressure of 6 to 8 GPa and a temperature of 1200 to 1600° C. to obtain a cBN sintered body of the present invention.
[Step 7] The cBN sintered body obtained in Step 6 is processed to a tool, and a cBN sintered body tool of the present invention is obtained.

The coated cBN sintered body tool of the present invention can be obtained by coating a film on the surface of the cBN sintered body tool of the present invention by the conventional CVD method or PVD method.

### Effects of the Invention

The cBN sintered body tool and coated cBN sintered body tool of the present invention are excellent in wear resistance and fracture resistance. The cBN sintered body and coated cBN sintered body tool of the present invention have effects that they can elongate the tool life than those of the conventional ones.

### EXAMPLE 1

cBN powder having an average particle size of 3.0 μm was prepared. As binder phase-forming powders, TiN powder having an average particle size of 1.5 μm and Al powder having an average particle size of 3.1 μm were prepared. As additives, Mo powder having an average particle size of 2.5 Ni powder having an average particle size of 2.5 μm and Ta powder having an average particle size of 4.0 μm were prepared. Then, they were weighed to the formulation composition shown in Table 1.

TABLE 1

| | | Formulation composition of | | | | | |
|---|---|---|---|---|---|---|---|
| | | raw powder (% by weight) | | | | | |
| | | | Powder for | | | | |
| | | | forming binder | | | | |
| | Sample | | phase | | Additives | | |
| | No. | cBN | TiN | Al | Mo | Ni | Ta |
| Present | 1 | 37.9 | 52.5 | 6.8 | 1 | 1 | 0.8 |
| products | 2 | 48.1 | 42.4 | 6.7 | 1 | 1 | 0.8 |
| Comparative | 3 | 31.4 | 59.6 | 6.2 | 1 | 1 | 0.8 |
| products | 4 | 49.5 | 43.6 | 6.9 | 0 | 0 | 0 |
| | 5 | 48.5 | 42.8 | 6.8 | 0.1 | 1 | 0.8 |

Among the weighed raw powders, the binder phase-forming powder and the additives which were other than the cBN powder was mixed by using a wet ball mill comprising balls of WC-based cemented carbide, an organic solvent and a pot, and the obtained mixed powder was subjected to heat treatment at a temperature of 850° C. to cause a reaction to make a phase having brittleness. The obtained phase having brittleness was finely pulverized by using a wet ball mill comprising balls of WC-based cemented carbide, an organic solvent and a pot. Next, the cBN powder was added to the finely pulverized powder of the phase having brittleness, and the resulting powders were further mixed by using a wet ball mill comprising balls of WC-based cemented carbide, an organic solvent and a pot for further 6 hours. Provided that with regard to Sample No. 5, it was mixed for 15 hours. The obtained mixed powder was placed in a Ta capsule, the Ta capsule was mounted to an ultra-high pressure and high temperature generating device and the powder was sintered at a pressure of 6 GPa and a temperature of 1200° C. to obtain cBN sintered bodies of Present products and Comparative products.

From the cross-sectional structure of the obtained cBN sintered body, % by volume of cBN, % by volume of the binder phase and its main composition, and each content (% by weight of each element based on the whole amount of the cBN sintered body) of the Mo element, Ni element, Ta element and W element contained in the whole cBN sintered body were measured by using a SEM, an image analyzer, an EDS and an X-ray diffractometer, and the values are shown in Table 2.

TABLE 2

| | | | | | Contents of Mo element, Ni | | | |
|---|---|---|---|---|---|---|---|---|
| | | | | | element, Ta element and W | | | |
| | | | | | element contained in cBN sintered | | | |
| | | cBN sintered body composition | | | body (% by weight of each element | | | |
| | | cBN | Binder phase | | based on whole cBN sintered body) | | | |
| | | Content | Content | | Mo | Ni | Ta | W |
| | Sample | (% by | (% by | Main | (% by | (% by | (% by | (% by |
| | No. | volume) | volume) | composition | weight) | weight) | weight) | weight) |
| Present | 1 | 45 | 55 | TiN, TiB₂, Al₂O₃, | 1 | 1 | 0.8 | 2.1 |
| products | | | | AlN, AlB₂, W₂B, | | | | |
| | | | | W, WC | | | | |
| | 2 | 55 | 45 | TiN, TiB₂, Al₂O₃, | 1 | 1 | 0.8 | 3.0 |
| | | | | AlN, AlB₂, W₂B, | | | | |
| | | | | W, WC | | | | |
| Comparative | 3 | 38 | 62 | TiN, TiB₂, Al₂O₃, | 1 | 1 | 0.8 | 1.6 |
| products | | | | AlN, AlB₂, W₂B, | | | | |
| | | | | W, WC | | | | |
| | 4 | 55 | 45 | TiN, TiB₂, Al₂O₃, | 0 | 0 | 0 | 3.1 |
| | | | | AlN, AlB₂, W₂B, | | | | |
| | | | | W, WC | | | | |
| | 5 | 55 | 45 | TiN, TiB₂, Al₂O₃, | 0.1 | 0.9 | 0.8 | 6.2 |
| | | | | AlN, AlB₂, W₂B, | | | | |
| | | | | W, WC | | | | |

The cBN sintered bodies of Samples Nos. 1 to 5 which had been cut to a predetermined shape by a wire electrical discharge machine were each attached to a cemented carbide substrate by brazing, and subjected to grinding to obtain cBN sintered body tools having an ISO standard CNGA120408 cutting insert shape with a cutting edge portion of which comprises the cBN sintered body and other than the cutting edge portion of which comprises the cemented carbide.

The following machining test was carried out by using the cBN sintered body tools of Present products and Comparative products. Tool lives of Present products and Comparative products are shown in Table 3.

### [Continuous Machining Test]

### Cutting way: Turning,

Work piece material: Hardened steel SCM415H (Shape: cylindrical),
Cutting speed: 180 m/min,
Feed rate: 0.15 mm/rev,

### Depth of cut: 0.15 mm,

### Environment: Wet,

Judgment criteria of tool life: When flank wear width of the cBN sintered body tool exceeded 0.15 mm, or fracture was generated, then, it was defined to be a tool life.

### [Interrupted Machining Test]

### Cutting way: Turning,

Work piece material: Hardened steel SCM415H (Shape: substantially cylindrical shape in which 2 V-shaped grooves were provided to the cylinder),
Cutting speed: 150 m/min,
Feed rate: 0.12 mm/rev,

### Depth of cut: 0.15 mm,

### Environment: Dry,

Judgment criteria of tool life: When the cBN sintered body tool was fractured, then, it was defined to be a tool life.

TABLE 3

| | | Tool life by | Tool life by |
|---|---|---|---|
| | | continuous | interrupted |
| | Sample | machining test | machining test |
| | No. | (min) | (min) |
| Present | 1 | 41 | 28 |
| products | 2 | 30 | 34 |
| Comparative | 3 | 29 | 15 |
| products | 4 | 24 | 25 |
| | 5 | 27 | 18 |

From Table 3, it can be understood that Present products are excellent in wear resistance and fracture resistance than those of Comparative products, and Present products have longer tool life than those of Comparative products.

### EXAMPLE 2

cBN powder having an average particle size of 3.0 μm was prepared. As binder phase-forming powders, TiN powder having an average particle size of 1.5 μm, Al powder having an average particle size of 3.1 μm, Co powder having an average particle size of 0.4 μm and WC powder having an average particle size of 2.0 μm were prepared. As additives, Mo powder having an average particle size of 2.5 μm, Ni powder having an average particle size of 2.5 μm and Ta powder having an average particle size of 4.0 μm were prepared. Then, they were weighed to the formulation composition shown in Table 4.

TABLE 4

| | | Formulation composition of | | | | | | | |
|---|---|---|---|---|---|---|---|---|---|
| | | raw powder (% by weight) | | | | | | | |
| | | | Powder for | | | | | | |
| | Sample | | forming binder phase | | | | Additives | | |
| | No. | cBN | TiN | Al | Co | WC | Mo | Ni | Ta |
| Present | 6 | 69.2 | 23.8 | 4.2 | 0 | 0 | 1 | 1 | 0.8 |
| products | 7 | 68.1 | 23.4 | 4.2 | 0 | 0 | 2.5 | 1 | 0.8 |
| | 8 | 69.6 | 23.9 | 4.2 | 0 | 0 | 0.5 | 1 | 0.8 |
| | 9 | 75.3 | 17.6 | 4.3 | 0 | 0 | 1 | 1 | 0.8 |
| | 10 | 68.0 | 0 | 3.8 | 19.9 | 5.5 | 1 | 1 | 0.8 |
| Com- | 11 | 71.1 | 24.5 | 4.4 | 0 | 0 | 0 | 0 | 0 |
| parative | 12 | 69.8 | 24.0 | 4.3 | 0 | 0 | 0.1 | 1 | 0.8 |
| products | 13 | 67.5 | 23.2 | 4.2 | 0 | 0 | 3.3 | 1 | 0.8 |
| | 14 | 69.9 | 0 | 3.9 | 20.5 | 5.7 | 0 | 0 | 0 |
| | 15 | 83.1 | 9.7 | 4.4 | 0 | 0 | 1 | 1 | 0.8 |

Among the weighed raw powders, the binder phase-forming powders and the additives which were other than the cBN powder was mixed by using a wet ball mill comprising balls of WC-based cemented carbide, an organic solvent and a pot, and the obtained mixed powder was subjected to heat treatment at a temperature of 850° C. to cause a reaction to make a phase having brittleness. The obtained phase having brittleness was finely pulverized by using a wet ball mill comprising balls of WC-based cemented carbide, an organic solvent and a pot. Next, the cBN powder was added to the finely pulverized powder of the phase having brittleness, and the resulting powders were further mixed by using a wet ball mill comprising balls of WC-based cemented carbide, an organic solvent and a pot for further 6 hours. The obtained mixed powder was placed in a Ta capsule, the Ta capsule was mounted to an ultra-high pressure and high temperature generating device and the powder was sintered at a pressure of 7.5 GPa and a temperature of 1600° C. to obtain cBN sintered bodies of Present products and Comparative products.

From the cross-sectional structure of the obtained cBN sintered body, % by volume of cBN, % by volume of the binder phase and its main composition, and each content (% by weight of each element based on the whole amount of the cBN sintered body) of the Mo element, Ni element, Ta element and W element contained in the whole cBN sintered body were measured by using a SEM, an image analyzer, an EDS and an X-ray diffractometer, and the values are shown in Table 5.

TABLE 5

| | | | | | Contents of Mo element, Ni | | | |
|---|---|---|---|---|---|---|---|---|
| | | | | | element, Ta element and W element | | | |
| | | cBN sintered body | | | contained in cBN sintered body (% | | | |
| | | composition | | | by weight of each element based on | | | |
| | | cBN | Binder phase | | whole cBN sintered body) | | | |
| | | Content | Content | | Mo | Ni | Ta | W |
| | Sample | (% by | (% by | Main | (% by | (% by | (% by | (% by |
| | No. | volume) | volume) | composition | weight) | weight) | weight) | weight) |
| Present | 6 | 75 | 25 | TiN, TiB₂, | 1 | 1 | 0.8 | 4.3 |
| products | | | | Al₂O₃, AlN | | | | |
| | | | | AlB₂, WB, | | | | |
| | | | | WC | | | | |
| | 7 | 75 | 25 | TiN, TiB₂, | 2.5 | 1 | 0.8 | 4.3 |
| | | | | Al₂O₃, AlN | | | | |
| | | | | AlB₂, WB, | | | | |
| | | | | WC | | | | |
| | 8 | 75 | 25 | TiN, TiB₂, | 0.5 | 1 | 0.8 | 4.3 |
| | | | | Al₂O₃, AlN | | | | |
| | | | | AlB₂, WB, | | | | |
| | | | | WC | | | | |
| | 9 | 80 | 20 | TiN, TiB₂, | 0.9 | 0.9 | 0.7 | 5.2 |
| | | | | Al₂O₃, AlN | | | | |
| | | | | AlB₂, WB, | | | | |
| | | | | WC | | | | |
| | 10 | 82 | 18 | W₂Co₂₁B₆, | 0.9 | 0.9 | 0.7 | 5.9 |
| | | | | Co₃W₃C, | | | | |
| | | | | CoWB, AlN, | | | | |
| | | | | Al₂O₃, WC | | | | |
| Com- | 11 | 75 | 25 | TiN, TiB₂, | 0 | 0 | 0 | 4.4 |
| parative | | | | Al₂O₃, AlN | | | | |
| products | | | | AlB₂, WB, | | | | |
| | | | | WC | | | | |
| | 12 | 75 | 25 | TiN, TiB₂, | 0.1 | 1 | 0.8 | 4.3 |
| | | | | Al₂O₃, AlN | | | | |
| | | | | AlB₂, WB, | | | | |
| | | | | WC | | | | |
| | 13 | 75 | 25 | TiN, TiB₂, | 3.3 | 1 | 0.8 | 4.2 |
| | | | | Al₂O₃, AlN | | | | |
| | | | | AlB₂, WB, | | | | |
| | | | | WC | | | | |
| | 14 | 82 | 18 | W₂Co₂₁B₆, | 0 | 0 | 0 | 5.9 |
| | | | | Co₃W₃C, | | | | |
| | | | | CoWB, AlN, | | | | |
| | | | | Al₂O₃, WC | | | | |
| | 15 | 86 | 14 | TiN, TiB₂, | 0.9 | 0.9 | 0.7 | 5.8 |
| | | | | Al₂O₃, AlN | | | | |
| | | | | AlB₂, WB, | | | | |
| | | | | WC | | | | |

The cBN sintered bodies of Samples Nos. 6 to 15 which had been cut to a predetermined shape by a wire electrical discharge machine were each attached to a cemented carbide substrate by brazing, and subjected to grinding to obtain cBN sintered body tools having an ISO standard CNGA120408 cutting insert shape with a cutting edge portion of which comprises the cBN sintered body and other than the cutting edge portion of which comprises the cemented carbide.

The following machining test was carried out by using the cBN sintered body tools of Present products and Comparative products. Tool lives of Present products and Comparative products are shown in Table 6.

### [Continuous Machining Test]

### Cutting way: Turning,

Work piece material: hardened steel SCM415H (Shape: cylindrical),
Cutting speed: 130 m/min,
Feed rate: 0.15 mm/rev,

### Depth of cut: 0.15 mm,

### Environment: Wet,

Judgment criteria of tool life: When flank wear width of the cBN sintered body tool exceeded 0.15 mm, or fracture was caused, then, it was defined to be a tool life.

### [Interrupted Machining Test]

### Cutting way: Turning,

Work piece material: Hardened steel SCM435H (Shape: substantially cylindrical shape in which 2 V-shaped grooves were provided to the cylinder),
Cutting speed: 130 m/min,
Feed rate: 0.15 mm/rev,

### Depth of cut: 0.15 mm,

### Environment: Wet,

Judgment criteria of tool life: When the cBN sintered body tool was fractured, then, it was defined to be a tool life.

TABLE 6

| | | Tool life by | Tool life by |
|---|---|---|---|
| | | continuous | interrupted |
| | Sample | machining test | machining test |
| | No. | (min) | (min) |
| Present | 6 | 15 | 18 |
| products | 7 | 14 | 17 |
| | 8 | 13 | 17 |
| | 9 | 13 | 25 |
| | 10 | 11 | 27 |
| Comparative | 11 | 8 | 10 |
| products | 12 | 10 | 14 |
| | 13 | 9 | 11 |
| | 14 | 7 | 16 |
| | 15 | 5 | 16 |

From Table 6, it can be understood that Present products are excellent in wear resistance and fracture resistance than those of Comparative products, and Present products have longer tool life than those of Comparative products.

### EXAMPLE 3

cBN powder having an average particle size of 3.0 μm was prepared. As binder phase-forming powders, TiC powder having an average particle size of 1.2 μm and Al powder having an average particle size of 3.1 μm were prepared. As additives, Mo powder having an average particle size of 2.5 Ni powder having an average particle size of 2.5 μm and Ta powder having an average particle size of 4.0 μm were prepared. Then, they were weighed to the formulation composition shown in Table 7.

TABLE 7

| | | Formulation composition | | | | | |
|---|---|---|---|---|---|---|---|
| | | of raw powder (% by weight) | | | | | |
| | | | Powder for | | | | |
| | | | forming binder | | | | |
| | Sample | | phase | | Additives | | |
| | No. | cBN | TiC | Al | Mo | Ni | Ta |
| Present | 16 | 58.3 | 31.2 | 6.2 | 1 | 2.5 | 0.8 |
| products | 17 | 59.5 | 31.9 | 6.3 | 1 | 0.5 | 0.8 |
| | 18 | 59.5 | 31.9 | 6.3 | 2.3 | 0 | 0 |
| Comparative | 19 | 60.3 | 32.3 | 6.4 | 0.1 | 0.1 | 0.8 |
| products | 20 | 58.4 | 31.3 | 6.2 | 0.1 | 3.2 | 0.8 |
| | 21 | 60.9 | 32.6 | 6.5 | 0 | 0 | 0 |

Among the weighed raw powders, the binder phase-forming powders and the additives which were other than the cBN powder was mixed by using a wet ball mill comprising balls of WC-based cemented carbide, an organic solvent and a pot, and the obtained mixed powder was subjected to heat treatment at a temperature of 850° C. to cause a reaction to make a phase having brittleness. The obtained phase having brittleness was finely pulverized by using a wet ball mill comprising balls of WC-based cemented carbide, an organic solvent and a pot. Next, the cBN powder was added to the finely pulverized powder of the phase having brittleness, and the resulting powders were further mixed by using a wet ball mill comprising balls of WC-based cemented carbide, an organic solvent and a pot for further 6 hours. The obtained mixed powder was placed in a Ta capsule, the Ta capsule was mounted to an ultra-high pressure and high temperature generating device and the powder was sintered at a pressure of 7 GPa and a temperature of 1300° C. to obtain cBN sintered bodies of Present products and Comparative products.

From the cross-sectional structure of the obtained cBN sintered body, % by volume of cBN, % by volume of the binder phase and its main composition, and each content (% by weight of each element based on the whole amount of the cBN sintered body) of the Mo element, Ni element, Ta element and W element contained in the whole cBN sintered body were measured by using a SEM, an image analyzer, an EDS and an X-ray diffractometer, and the values are shown in Table 8.

TABLE 8

| | | | | | Contents of Mo element, Ni | | | |
|---|---|---|---|---|---|---|---|---|
| | | | | | element, Ta element and W | | | |
| | | | | | element contained in cBN sintered | | | |
| | | | | | body (% by weight of each | | | |
| | | cBN sintered body composition | | | element based on whole cBN | | | |
| | | cBN | Binder phase | | sintered body) | | | |
| | | Content | Content | | Mo | Ni | Ta | W |
| | Sample | (% by | (% by | Main | (% by | (% by | (% by | (% by |
| | No. | volume) | volume) | composition | weight) | weight) | weight) | weight) |
| Present | 16 | 65 | 35 | TiC, TiB₂, Al₂O₃, | 1 | 2.5 | 0.8 | 3.6 |
| products | | | | AlN, AlB₂, W₂B, | | | | |
| | | | | WC | | | | |
| | 17 | 65 | 35 | TiC, TiB₂, Al₂O₃, | 1 | 0.5 | 0.8 | 3.6 |
| | | | | AlN, AlB₂, W₂B, | | | | |
| | | | | WC | | | | |
| | 18 | 65 | 35 | TiC, TiB₂, Al₂O₃, | 2.3 | 0 | 0 | 3.6 |
| | | | | AlN, AlB₂, W₂B, | | | | |
| | | | | WC | | | | |
| Com- | 19 | 65 | 35 | TiC, TiB₂, Al₂O₃, | 0.1 | 0.1 | 0.8 | 3.7 |
| parative | | | | AlN, AlB₂, W₂B, | | | | |
| products | | | | WC | | | | |
| | 20 | 65 | 35 | TiC, TiB₂, Al₂O₃, | 0.1 | 3.2 | 0.8 | 3.5 |
| | | | | AlN, AlB₂, W₂B, | | | | |
| | | | | WC | | | | |
| | 21 | 65 | 35 | TiC, TiB₂, Al₂O₃, | 0 | 0 | 0 | 3.7 |
| | | | | AlN, AlB₂, W₂B, | | | | |
| | | | | WC | | | | |

The cBN sintered bodies of Samples Nos. 16 to 21 which had been cut to a predetermined shape by a wire electrical discharge machine were each attached to a cemented carbide substrate by brazing, and subjected to grinding to obtain cBN sintered body tools having an ISO standard CNGA120408 cutting insert shape with a cutting edge portion of which comprises the cBN sintered body and other than the cutting edge portion of which comprises the cemented carbide. The following machining test was carried out by using the obtained cBN sintered body tools. Tool lives of the cBN sintered body tools are shown in Table 9.

### [Continuous Machining Test]

### Cutting way: Turning,

Work piece material: Hardened steel SCM415H (Shape: cylindrical),
Cutting speed: 150 m/min,
Feed rate: 0.15 mm/rev,

### Depth of cut: 0.15 mm,

### Environment: Wet,

Judgment criteria of tool life: When flank wear width of the cBN sintered body tool exceeded 0.15 mm, or fracture was generated, then, it was defined to be a tool life.

### [Interrupted Machining Test]

### Cutting way: Turning,

Work piece material: Hardened steel SCM435H (Shape: substantially cylindrical shape in which 2 V-shaped grooves were provided to the cylinder),
Cutting speed: 130 m/min,
Feed rate: 0.15 mm/rev,

### Depth of cut: 0.15 mm,

### Environment: Dry,

Judgment criteria of tool life: When the cBN sintered body tool was fractured, then, it was defined to be a tool life.

TABLE 9

| | | Tool life by | Tool life by |
|---|---|---|---|
| | | continuous | interrupted |
| | Sample | machining test | machining test |
| | No. | (min) | (min) |
| Present | 16 | 25 | 39 |
| products | 17 | 24 | 37 |
| | 18 | 23 | 36 |
| Comparative | 19 | 21 | 33 |
| products | 20 | 22 | 29 |
| | 21 | 19 | 26 |

From Table 9, it can be understood that Present products are excellent in wear resistance and fracture resistance than those of Comparative products, and Present products have longer tool life than those of Comparative products.

### EXAMPLE 4

cBN powder having an average particle size of 3.0 μm was prepared. As binder phase-forming powders, TiCN powder having an average particle size of 0.8 μm and Al powder having an average particle size of 3.1 μm were prepared. As additives, Mo powder having an average particle size of 2.5 Ni powder having an average particle size of 2.5 μm and Ta powder having an average particle size of 4.0 μm were prepared. Then, they were weighed to the formulation composition shown in Table 10.

TABLE 10

| | | Formulation composition of raw powder | | | | | |
|---|---|---|---|---|---|---|---|
| | | (% by weight) | | | | | |
| | | | Powder for forming | | | | |
| | Sample | | binder phase | | Additives | | |
| | No. | cBN | TiCN | Al | Mo | Ni | Ta |
| Present | 22 | 62.4 | 27.5 | 5.5 | 1 | 1 | 2.6 |
| products | 23 | 63.2 | 27.8 | 5.6 | 1 | 1 | 1.4 |
| Comparative | 24 | 64.7 | 28.42 | 5.7 | 0.1 | 1 | 0.08 |
| products | 25 | 62.3 | 27.4 | 5.5 | 0.1 | 1 | 3.7 |
| | 26 | 65.5 | 28.8 | 5.7 | 0 | 0 | 0 |

Among the weighed raw powders, the binder phase-forming powders and the additives which were other than the cBN powder was mixed by using a wet ball mill comprising balls of WC-based cemented carbide, an organic solvent and a pot, and the obtained mixed powder was subjected to heat treatment at a temperature of 850° C. to cause a reaction to make a phase having brittleness. The obtained phase having brittleness was finely pulverized by using a wet ball mill comprising balls of WC-based cemented carbide, an organic solvent and a pot. Next, the cBN powder having an average particle size of 3.0 μm was added to the finely pulverized powder of the phase having brittleness, and the resulting powders were further mixed by using a wet ball mill comprising balls of WC-based cemented carbide, an organic solvent and a pot for further 6 hours. The obtained mixed powder was placed in a Ta capsule, the Ta capsule was mounted to an ultra-high pressure and high temperature generating device and the powder was sintered at a pressure of 7.2 GPa and a temperature of 1400° C. to obtain cBN sintered bodies of Present products and Comparative products.

From the obtained cross-sectional structure of the cBN sintered body, % by volume of cBN, % by volume of the binder phase and its main composition, and each content (% by weight of each element based on the whole amount of the cBN sintered body) of the Mo element, Ni element, Ta element and W element contained in the whole cBN sintered body were measured by using a SEM, an image analyzer, an EDS and an X-ray diffractometer, and the values are shown in Table 11.

TABLE 11

| | | | | | Contents of Mo element, Ni | | | |
|---|---|---|---|---|---|---|---|---|
| | | | | | element, Ta element and W element | | | |
| | | cBN sintered body | | | contained in cBN sintered body | | | |
| | | composition | | | (% by weight of each element | | | |
| | | cBN | Binder phase | | based on whole cBN sintered body) | | | |
| | | Content | Content | | Mo | Ni | Ta | W |
| | Sample | (% by | (% by | Main | (% by | (% by | (% by | (% by |
| | No. | volume) | volume) | composition | weight) | weight) | weight) | weight) |
| Present | 22 | 70 | 30 | TiCN, TiB₂, | 1 | 1 | 2.6 | 3.8 |
| Products | | | | Al₂O₃, AlN | | | | |
| | | | | AlB₂, WB, | | | | |
| | | | | WC | | | | |
| | 23 | 70 | 30 | TiCN, TiB₂, | 1 | 1 | 1.4 | 3.9 |
| | | | | Al₂O₃, AlN | | | | |
| | | | | AlB₂, WB, | | | | |
| | | | | WC | | | | |
| Com- | 24 | 70 | 30 | TiCN, TiB₂, | 0.1 | 1 | 0.08 | 3.9 |
| parative | | | | Al₂O₃, AlN | | | | |
| Products | | | | AlB₂, WB, | | | | |
| | | | | WC | | | | |
| | 25 | 70 | 30 | TiCN, TiB₂, | 0.1 | 1 | 3.7 | 3.7 |
| | | | | Al₂O₃, AlN | | | | |
| | | | | AlB₂, WB, | | | | |
| | | | | WC | | | | |
| | 26 | 70 | 30 | TiCN, TiB₂, | 0 | 0 | 0 | 3.9 |
| | | | | Al₂O₃, AlN | | | | |
| | | | | AlB₂, WB, | | | | |
| | | | | WC | | | | |

The cBN sintered bodies of Samples Nos. 22 to 26 which had been cut to a predetermined shape by a wire electrical discharge machine were each attached to a cemented carbide substrate by brazing, and subjected to grinding to obtain cBN sintered body tools having an ISO standard CNGA120408 cutting insert shape. With regard to Sample No. 23, an (Al,Cr)N film having an average film thickness of 1.3 μm was coated on the surface of the cBN sintered body tool of Sample No. 23 by the PVD method to obtain a coated cBN sintered body tool. The following machining test was carried out by using the obtained cBN sintered body tools of Sample Nos. 22 and 24 to 26 and the coated cBN sintered body tool of Sample No. 23. Tool lives of the cBN sintered body tools and the coated cBN sintered body tools are shown in Table 12.

### [Continuous Machining Test]

### Cutting way: Turning,

Work piece material: Hardened steel SCM415H (Shape: cylindrical),
Cutting speed: 130 m/min,
Feed rate: 0.15 mm/rev,

### Depth of cut: 0.15 mm,

### Environment: Wet,

Judgment criteria of tool life: When flank wear width of the cBN sintered body tool or the coated cBN sintered body tool exceeded 0.15 mm, or fracture was generated, then, it was defined to be a tool life.

### [Interrupted Machining Test]

### Cutting way: Turning,

Work piece material: Hardened steel SCM435H (Shape: substantially cylindrical shape in which 2 V-shaped grooves were provided to the cylinder),
Cutting speed: 130 m/min,
Feed rate: 0.15 mm/rev,

### Depth of cut: 0.15 mm,

### Environment: Wet,

Judgment criteria of tool life: When the cBN sintered body tool or the coated cBN sintered body tool was fractured, then, it was defined to be a tool life.

TABLE 12

| | | Tool life by | Tool life by |
|---|---|---|---|
| | | continuous | interrupted |
| | Sample | machining test | machining test |
| | No. | (min) | (min) |
| Present | 22 | 24 | 13 |
| products | 23 | 33 | 12 |
| Comparative | 24 | 18 | 10 |
| products | 25 | 19 | 8 |
| | 26 | 16 | 9 |

From Table 12, it can be understood that Present products are excellent in wear resistance and fracture resistance than those of Comparative products, and Present products have longer tool life than those of Comparative products.

1. A cBN sintered body tool comprising a cBN sintered body which comprises 40 to 85% by volume of cBN, and the remainder being a binder phase and inevitable impurities, wherein the binder comprises at least one selected from at least one metal selected from Ti, Zr, Hf, V, Nb, Ta, Cr, Mo, W, Co, Ni and Al, and at least one of a carbide, a nitride, a carbonitride, a boride and an oxide of these metals and mutual solid solutions thereof, wherein an amount of a Mo element contained in the cBN sintered body is 0.2 to 3.0% by weight based on a whole amount of the cBN sintered body.

2. The cBN sintered body tool according to claim 1, wherein an amount of the Mo element contained in the cBN sintered body is 0.2 to 2.5% by weight based on the whole amount of the cBN sintered body.

3. The cBN sintered body tool according to claim 1, wherein an amount of a Ni element contained in the cBN sintered body is 3.0% by weight or less based on the whole amount of the cBN sintered body.

4. The cBN sintered body tool according to claim 1, wherein an amount of a Ni element contained in the cBN sintered body is 0.2 to 3.0% by weight based on the whole amount of the cBN sintered body.

5. The cBN sintered body tool according to claim 1, wherein an amount of a Ni element contained in the cBN sintered body is 0.2 to 2.5% by weight based on the whole amount of the cBN sintered body.

6. The cBN sintered body tool according to claim 1, wherein an amount of a Ta element contained in the cBN sintered body is 3.5% by weight or less based on the whole amount of the cBN sintered body.

7. The cBN sintered body tool according to claim 1, wherein an amount of a Ta element contained in the cBN sintered body is 0.1 to 3.5% by weight based on the whole amount of the cBN sintered body.

8. The cBN sintered body tool according to claim 1, wherein an amount of a Ta element contained in the cBN sintered body is 0.5 to 3.0% by weight based on the whole amount of the cBN sintered body.

9. The cBN sintered body tool according to claim 1, wherein an amount of a W element contained in the cBN sintered body is 0 to 6% by weight based on the whole amount of the cBN sintered body.

10. The cBN sintered body tool according to claim 1, wherein an amount of a W element contained in the cBN sintered body is 0 to 5% by weight based on the whole amount of the cBN sintered body.

11. The cBN sintered body tool according to claim 1, wherein an amount of a W element contained in the cBN sintered body is 0 to 3% by weight based on the whole amount of the cBN sintered body.

12. The cBN sintered body tool according to claim 1, wherein the binder phase comprises at least one selected from the group consisting of TiN, TiCN, TiC, TiB₂, TiBN, TiAlN, Ti₂AlN, AN, AlB₂, AlB₁₂, Al₂O₃, ZrC, HfC, VC, NbC, Cr₃C₂, Mo₂C, TaC, ZrN, HfN, VN, NbN, TaN, CrN, WC, WB, W₂B, CoWB, W₂Co₂₁B₆, Co₃W₃C, W, Mo, Co, Ni and mutual solid solutions thereof.

13. The cBN sintered body tool according to claim 1, wherein the binder phase comprises at least one selected from the group consisting of TiN, TiCN, TiC, TiB₂, MN, AlB₂, AlB₁₂, Al₂O₃, Mo₂C, TaC, TaN, CrN, WC, WB, W₂B, CoWB, W₂Co₂₁B₆, Co₃W₃C, W, Mo, Co, Ni and mutual solid solutions thereof.

14. A coated cBN sintered body tool which comprises the cBN sintered body tool according to claim 1, a surface of which is coated by a film.

15. The coated cBN sintered body tool according to claim 14, wherein the film comprises at least one selected from the group consisting of an oxide, a carbide, a nitride, a carbonitride and a boride of at least one metal selected from Ti, Zr, Hf, V, Nb, Ta, Cr, Mo, W, Al and Si, and mutual solid solutions thereof.

16. The coated cBN sintered body tool according to claim 14, wherein the film comprises at least one selected from the group consisting of TiN, TiC, TiCN, (Ti,Al)N, (Ti,Si)N, (Al,Cr)N and Al₂O₃.

17. The coated cBN sintered body tool according to claim 14, wherein the film is a single layer film or a laminated film of two or more layers.

18. The coated cBN sintered body tool according to claim 14, wherein the film is an alternately laminated film in which thin films each having different composition with an average film thickness of 5 to 200 nm are alternately laminated.

19. The coated cBN sintered body tool according to claim 14, wherein a total film thickness of the whole film is 0.5 to 20 μm in an average film thickness.

20. The coated cBN sintered body tool according to claim 14, wherein a total film thickness of the whole film is 1 to 4 μm in an average film thickness.
